(19) United States
(12) Patent Application Publication
(10) Pub. No.: US 2007/0193337 A1
(43) Pub. Date: Aug. 23, 2007

(54) Gas sensor with caulked portion for fixedly holding gas sensing element and method for producing the same

(75) Inventor: Keiji Kanao, Chita-gun (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/707,162

(22) Filed: Feb. 16, 2007

(30) Foreign Application Priority Data
Feb. 17, 2006 (JP) 2006-041348

(51) Int. Cl. G01N 27/00; G01N 27/409; G01M 15/10

(52) U.S. Cl. 73/31.05; 73/23.2; 204/424

(57) ABSTRACT

A gas sensor comprises a gas sensing element, an insulator, and a housing. The gas sensor element senses information indicative of a concentration of a specific gas to be measured and has a longitudinal direction and a radial direction perpendicular to the longitudinal direction. In the insulator, the gas sensing element is fixedly inserted. The housing has a hollow in which the insulator with the gas sensing element is inserted from an opening of hollow and has a wall portion positioned to form the opening in the longitudinal direction. The wall portion includes a caulked portion bent inward in the radial direction and has a thickness in the radial direction between an inner and an outer wall surfaces. The thickness and at least one of the inner and the outer wall surface change continuously in the longitudinal direction. In other word, the caulked portion has the holding means is accompanied by traveling a caulked force imparted by the caulked portion so as to insert the insulator into the hollow of the housing in a matter that a reaction force against the caulked force is distributed uniformly to an overall of the wall portion.

### CROSS REFERENCE TO RELATED APPLICATION

The present application relates to and incorporated by reference Japanese Patent Application No. 2006-041348 filed on Feb. 17, 2006.

### BACKGROUND OF THE INVENTION

1. The Field of the Invention

The present invention relates to a gas sensor and a method for manufacturing the same, and in particular, to the gas sensor for detecting the concentration of a specific gas component contained in a gas to be measured, such as an exhaust gas emitted from an internal combustion engine for an automotive vehicle, in order to utilize detected results for various types of control such as combustion control.

2. Description of the Prior Art

In manufacturing internal combustion engines for automotive vehicles, environmental friendliness is one significant key word. From this viewpoint, attempts have continuously been made to get better gas mileage and to emit cleaner exhaust gasses. One of such attempts is fuel burning control which is carried out using the oxygen content contained in an exhaust gas, in which the content serves as a parameter indicating an air-fuel ratio. To this end, a gas sensor is used for measuring the oxygen content in an exhaust gas installed in an exhaust system such as an exhaust manifold or an exhaust gas pipe of an automotive combustion engine. Such a gas sensor includes a gas sensing element for detecting a specific gas component of a gas being measured.

The gas sensing element generally has an electrochemical cell comprising a solid electrolyte and a pair of electrodes. The gas sensor is made to measure an oxygen concentration or the like of a measured gas on the basis of an electromotive force generating between the electrodes, with the atmospheric gas used as a reference gas. Accordingly it is required for the gas sensing element to be exposed to both the atmosphere gas and a gas to be measured. Thus the gas sensing element is disposed to be in both an atmospheric ambience and a gas-being-measured ambience, where the atmospheric and gas-being-measured ambiences are separated from each other in an air-tight manner.

The gas sensor installed in an exhaust system for measuring a specific gas component of a gas to be measured is exposed to harsh environments such as high temperature, hard vibration and so on. Parts of the gas sensor are therefore fixedly assembled by mutually caulking and welding, because fastening with screws is insufficient to fixedly assemble the parts.

For example, a gas sensor generally comprises a gas sensing element, a hollow cylindrical housing having a mounting hole and a wall portion to form the opening, an atmospheric-side cover, and a measured gas-side cover. The sensing element is inserted through a device-side insulator into an inner surface of the mounting hole of the hollow cylindrical housing.

The wall portion has a body portion at a distal end thereof and a caulked portion at the opposite end to the distal end. The caulked portion is, before caulking, called a proximal end portion having an upstanding, hollow cylindrical shape, and is formed by the processes which include bending the proximal end portion of the wall portion in an inward direction by caulking to hold the device-side insulator. The measured gas-side cover is installed at the distal end of the hollow cylindrical housing, and is supported by the body portion of the wall portion. The interiors of the atmosphere side cover and the measured gas-side cover come into the atmospheric ambiance or the measured gas environment, respectively.

The device-side insulator is provided for hermetically sealing both a distal end surface of the atmospheric ambience and a proximal end surface of the measured gas environment, and is fixed by a caulking force imparted by the caulked portion of the wall portion.

Furthermore, in recent years, the regulation on exhaust gas emitted from an internal combustion engine for an automotive vehicle has become stricter every year and, with this situation, improving fuel efficiency and output in power of a combustion engine for an automotive vehicle is required. At the same time, the temperature of exhaust gas is further increasing. This fact leads to an increase in the temperature of every part for the gas sensor since sometimes the gas sensor is used in a state inserted into an exhaust pipe of a combustion engine for an automotive vehicle to be exposed to an exhaust gas. Thus there is a possibility that long term usage of the gas sensor in such a situation may result in decreasing the caulking force imparted by the caulked portion of the wall portion to fixedly hold the device-side insulator. At simultaneously reducing the hermeticity of the boundary between the atmospheric ambience and the measured gas environment is attained.

To avoid the above-mentioned problems, it can be considered that a caulking load for bending the proximal end portion of the wall portion in the inward direction to form the caulked portion is increased so as to fixedly hold after caulking the device-side insulator by the caulking force. The caulking force is imparted by the caulked portion of the wall portion with a sufficient strength even though the temperature of the exhaust gas increases.

However, it may occur that simply increasing the caulking load causes the wall portion to bulge in an outward direction. In such situation, it becomes difficult to install the atmospheric-side cover on the hollow cylindrical housing.

Further it also may occur that increasing the caulking load make it impossible to attain an accurate caulking, i.e., making it impossible to prevent a variation of the position at which the wall portion is bent from product to product. Such variation of the position causes difficulty for caulked fixing of the device-side insulator so as to be disposed into the mounting hole of the hollow cylindrical housing. This leads to the reduction of the hermeticity of the boundary between the atmospheric ambience and the measured gas environment.

Several attempts for preventing variation of the above mentioned positions at which the wall portion is bent are disclosed in Japanese Patent Laid-open Publication No. 2001-249105, U.S. Pat. No. 6,513,363, and U.S. Pat. No. 6,446,489. A gas sensor disclosed in these references has a hollow cylindrical housing having at a distal end thereof a wall portion being shaped so as to vary suddenly in order to prevent variation of the position at which the wall portion is bent with caulking. Another gas sensor is also disclosed in these references such that an annular groove is formed with the inner peripheral wall of the wall portion at which the wall portion is bent with caulking. Therefore it is possible to reduce the variation of the position at which the wall portion is bent. However it may occur that a crack may start in the wall portion at which the thickness changes suddenly in the radial direction or at the groove when an excessive concentration of stress is applied.

### SUMMARY OF THE INVENTION

The present invention has been developed to improve the above-mentioned conventional problems, and it is therefore an object of the present invention to provide a gas sensor which is capable of avoiding the reduction of the hermeticity of the boundary between the atmospheric ambience and the measured gas environment by keeping sufficient strength of the caulking force applying to the device-side insulator. It is a further object of the present invention to provide a method for producing such a gas sensor as mentioned above.

According to a first aspect of the invention, there is provided a gas sensor comprises a gas sensing element, an insulator, and a housing. The gas sensor element senses information indicative of a concentration of a specific gas to be measured, and has an axial direction and a radial direction perpendicular to the axial direction. In the insulator, the gas sensing element is fixedly inserted. The housing has a hollow in which the insulator with the gas sensing element is inserted from an opening of hollow and has a wall portion positioned to form the opening in the axial direction. The wall portion includes a caulked portion at the proximal end thereof bent inward in the radial direction and a body portion at the opposite end of the caulked portion. The wall portion has a thickness in the radial direction between an inner and an outer wall surfaces. The caulking portion is called before caulking a proximal end portion. The thickness and at least one of the inner and the outer wall surface change continuously in the axial direction.

Preferably, the wall portion has a tapered portion provided between the body portion and the caulked portion in the axial direction, the tapered portion being shaped such that an outer peripheral surface thereof having a diameter in the radial direction becoming smaller as approaching from the body portion to the caulked portion along an axial direction of the gas sensor.

In the tapered portion of wall portion of the gas sensor, a thickness of the wall portion is shaped so as not to change sharply. In other word, the caulked portion has the holding means which is accompanied by traveling a caulked force imparted by the caulked portion so as to insert the insulator into the hollow of the housing in a matter that a reaction force against the caulked force is distributed uniformly to an overall of the wall portion. Therefore, it is possible to prevent an excessive concentration of stress from being applied locally to the wall portion.

Further, when the proximal end portion of the wall portion is bent in an inward direction in order to form the caulked portion by caulking, it becomes possible that the position at which the wall portion is bent is set at just above the proximal end of the tapered portion. As a result, a variation of the aforementioned position is reduced to a sufficiently small one. Then it is capable of making the insulator to be fixedly accommodated into a mounting hole of the housing by the caulking force imparted by the caulked portion of the wall portion. In other word, the caulked portion has the holding means is accompanied by traveling a caulked force imparted by the caulked portion so as to insert the insulator into the hollow of the housing in a matter that a reaction force against the caulked force is distributed uniformly to an overall of the wall portion. As a result, for a long usage of the gas sensor, it is possible to keep the hermeticity of the boundary between the atmospheric ambience and the measured gas environment in a reliable manner.

According to a second aspect of the invention, there is provided a method for producing a gas sensor, comprising steps of: preparing components which includes a gas sensor element, a housing, and an insulator, wherein the gas sensor senses information indicative of a concentration of a specific gas to be measured and has a axial direction and a radial direction perpendicular to the axial direction, the housing has a hollow, and a wall portion positioned to form the opening in the axial direction, and the wall portion includes a proximal end portion being called a caulked portion after caulking and has a thickness in the radial direction between an inner and an outer wall surfaces, and the thickness and at least one of the inner and the outer wall surface change continuously in the axial direction, and an insulator fills an interstices in the hollow between an outer surface of the gas sensing element and the inner wall surface, inserting the gas sensing element from an opening of hollow into the housing through which the gas sensing element is inserted, and caulking a proximal end portion of the wall portion inward in a plane perpendicular to the axial direction so as to form the caulked portion.

According to the second aspect, the similar or identical advantage can be provided.

The gas sensor according to the present invention includes oxygen sensors, NOx sensors and other gas sensors such as air-fuel ratio sensors made to measure an air-fuel ratio in a combustion chamber of a vehicle on the basis of an oxygen concentration in an exhaust gas and others.

### BRIEF DESCRIPTION OF THE DRAWINGS

In the accompanying drawings:

FIG. 1 is an axial sectional view showing a gas sensor according to a first embodiment of the invention;

FIG. 2 is an axial partial sectional view of a wall portion of a hollow cylindrical housing of the gas sensor, before caulking, according to the first embodiment;

FIG. 3 is an axial partial sectional view showing the wall portion of the hollow cylindrical housing of the gas sensor, after caulking, according to the first embodiment;

FIG. 4 is an axial sectional view of a gas sensor according to a second embodiment of the invention;

FIG. 5 is an axial partial sectional view showing a wall portion of a hollow cylindrical housing of a gas sensor, before caulking, according to the second embodiment;

FIG. 6 is an axial partial sectional view showing the wall portion of the hollow cylindrical housing of the gas sensor, after caulking, according to the second embodiment;

FIG. 7 is a partial sectional view showing a surface of axial and distal ends of a buckling portion of the wall portion, in which the surface indicates there are not any imperfections such as burrs thereon;

FIG. 8 is a partial sectional view showing a surface of axial and distal ends of the buckling portion of the wall portion, in which the surface indicates there is an imperfection, in this case a burr, thereon;

FIG. 9 is a comparative graphical representation concerning various positions at each of which the wall portion is bent in gas sensors according to the first embodiment;

FIG. 10 is a partial sectional view of the gas sensor according to the first embodiment, the view showing a position at which the wall portion is bent;

FIG. 11 is a comparative graphical representation concerning bulging lengths of gas sensors tested according to the first embodiment;

FIG. 12 is a graphical representation concerning maximal values and average values of the bulging lengths, in which curves are expressed as a function of the slopes θ of thin portions of the wall portions in gas sensors tested according to the second embodiment;

FIG. 13 is a graphical representation concerning leakage rates, which are expressed as a function of values of A/B in the gas sensors tested according to the second embodiment;

FIG. 14 show plotted graphs explaining endurance tested with the gas sensors according to the second embodiment when the wall portion becomes cracked;

FIG. 15 is a partial sectional view showing a wall portion of a hollow cylindrical housing of a conventional type of gas sensor;

FIG. 16 exemplifies an imperfection occurring at a wall portion of a hollow cylindrical housing of a conventional type of gas sensor;

FIG. 17 illustrates a producing process according to the first embodiment; and

FIG. 18 illustrates a producing process according to the second embodiment.

### DETAILED DESCRIPTION OF THE PRESENT EMBODIMENTS

Various embodiments of the present invention will now be described hereafter with references to accompanying drawings.

### First Embodiment

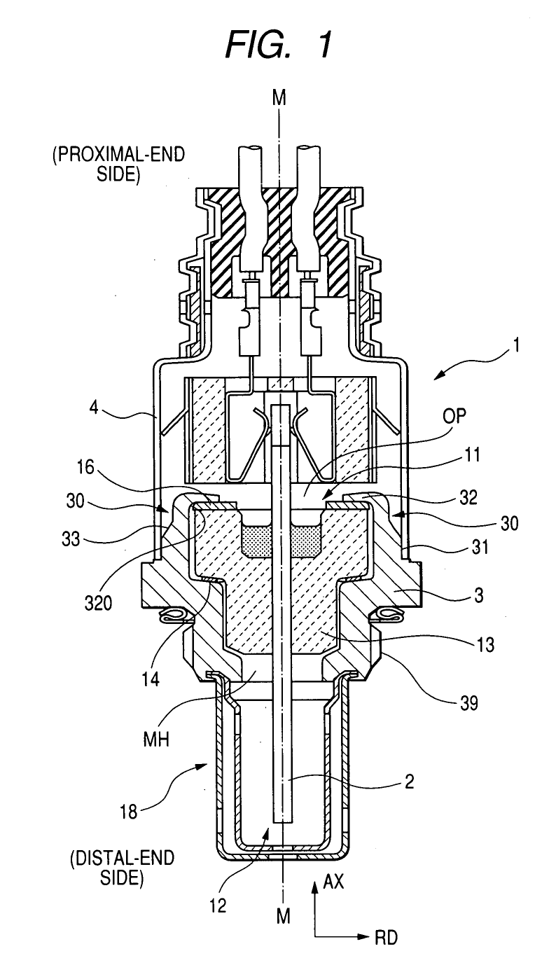

Referring to FIGS. 1 to 3, and FIG. 17, a first embodiment of a gas sensor will now be described. The description will be given on the condition that the gas sensor has an axial (i.e., longitudinal) direction AX, an axial distal end which is located in an exhaust system such as exhaust manifold or an exhaust gas pipe of an automotive combustion engine, and an axial end which is opposite to the distal end and referred to as a proximal end. A radial direction RD is defined as a perpendicular direction to the axial direction AX.

As shown in FIG. 1, a gas sensor 1 according the first embodiment of the present invention includes a gas sensing element 2, a hollow cylindrical housing having a mounting hole MH and a wall portion 30 at the axial end thereof 3, an atmospheric-side cover 4, a measured gas-side cover 18. The mounting hole MH corresponds to a hollow according to the present invention. The sensing element 2 is inserted through a device-side insulator 13 into the mounting hole of the hollow cylindrical housing from the opening OP.

In the following the diameter of a surface of the parts of the gas sensor 1 having a rotational symmetry, such as, the hollow cylindrical housing 3, the device-side insulator 13, is defined as the nearest distance from the center axis M of the gas sensor 1 to the surface along the radial direction.

On the distal end of the hollow cylindrical housing 3, the measured gas-side cover 18 is provided so as to cover a gas concentration detecting portion of the distal end of the gas sensing element 2. On the proximal end of the hollow cylindrical housing 3, the atmospheric-side cover is provided. It is usual that the hollow cylindrical housing is made of a ferritic stainless steel of a high corrosion resistance. The device-side insulator 13 is accommodated into the mounting hole of the hollow cylindrical housing 3 by the sufficiently strong caulking force imparted by the caulked portion of the wall portion 32. At the same time, the gas sensing element 2 is inserted into and fixedly held by the device-side insulator 13. As a result, it is possible to keep the reliable hermeticity of the boundary between the atmospheric ambience and the measured gas environment.

The gas sensor 1 includes an oxygen sensor, an NOx sensor and other gas sensors such as an air-fuel ratio sensor.

For example, an oxygen sensor comprising an oxygen sensing element formed of an oxygen ion conductive solid-state electrolyte is known. The sensing element comprises an internal electrode and an external electrode provided respectively on the inner and outer surface of the element body of a cylindrical shape with a bottom wherein one end is closed by a solid-state electrolyte and the other end is left open. An electromotive force is generated between the internal electrode and the external electrode depending on the difference in the concentration of oxygen between an atmospheric ambience with which the internal electrode comes into contact and a measured gas environment with which the external electrode comes into contact. Then it is possible to determine the oxygen concentration of the measured gas environment based on the electromotive force generated between the internal electrode and the external electrode.

As shown in FIGS. 1 to 3, the wall portion 30 of the hollow cylindrical housing 4 has a body portion 31 at an distal end thereof, at the opposite end thereof a caulked portion 32 which is formed by bending a proximal end portion thereof in an inward direction, and a tapered portion 33 provided between the caulked portion 32 and the body portion 30. The wall portion 30 has also an outer wall surface OW and an inner wall surface IW.

The atmospheric-side cover 4 is supported by the body portion 31. The tapered portion is shaped such that an outer surface thereof has a diameter and a thickness TH between the outer wall surface OW and the inner one IW becomes smaller as approaching from the body portion to the caulked portion.

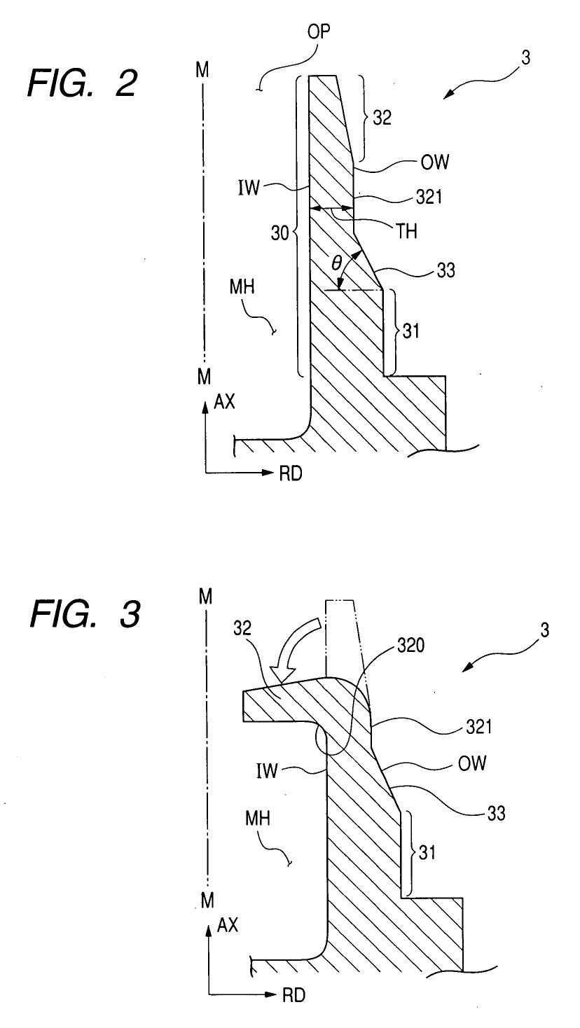

In this embodiment, the slope of the outer surface of the tapered portion along the axial direction θ is larger than or equal to 45 degrees, as shown in FIG. 2.

A packing 14 is placed between the device-side insulator 13 and the hollow cylindrical housing 3 to inhibit the flow of a gas. At the proximal end portion of the device-side insulator 13, a spring 16 is provided so as to be pressed toward the distal end of the mounting hole of the hollow cylindrical housing 3 by the caulked portion 32.

To measure a concentration of a gas component in a gas by the gas sensor 1, the atmosphere is introduced into the interior of the atmospheric-side cover 4 to come into an atmospheric ambience 11, while the measured gas is introduced into the interior of the measured gas-side cover 18 to come into a measured gas environment 12.

In order to insert the device-side insulator 13 into the hollow cylindrical housing 3, as a first step the distal end of the device-side insulator 13 into which the sensing element 2 is fixedly inserted is penetrated through the ring shaped packing 14. Then the device-side insulator 13 is inserted into the mounting hole of the hollow cylindrical housing 3. After these processes, the packing 14 has been brought into contact with both the device-side insulator 13 and the hollow cylindrical housing 3.

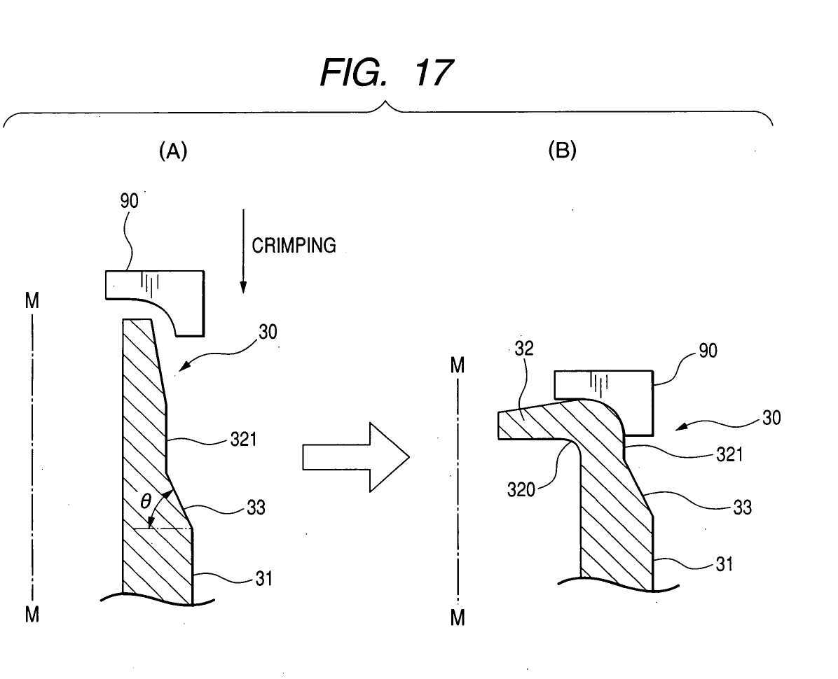

Then, as shown in FIG. 17, the proximal end portion of the wall portion 30 is bent in an inward direction at a bending point 320 by the pressure force imparted by a caulking material 90. Therefore the caulking portion 30 has been formed as a part of the wall portion 30 of the hollow cylindrical housing 3.

As shown in FIG. 1, the spring 16 is subjected to the caulking force imparted by the caulking portion 32 toward the distal end of the gas sensor 1. Furthermore, the device-side insulator 13 is inserted toward the distal end direction through the spring 16. Therefore it is realized that the device-side insulator 13 is brought into intimate contact with the hollow cylindrical housing 3 via the packing 14. That is, the packing 14 being subjected to the pressing force toward the distal end direction imparted by the caulking portion 32 is served as the hermitic boundary between the atmospheric ambience 11 and the measured gas environment 12.

As stated above, the gas sensor 1 as shown in FIGS. 1 to 3 is provided with the tapered portion 33 between the caulking portion 32 and the body portion 31. In the tapered portion 33, the outer peripheral surface thereof has a diameter becoming smaller as approaching from the body portion to the buckling portion. That is, since the tapered portion 33 is shaped so as not to vary in thickness suddenly, it is possible to prevent from applying an excessive concentration of stress on a small region of the wall portion 30.

Furthermore, as shown in FIG. 17, during bending of the proximal end portion of the wall portion 30 in the inward direction in order to form the caulking portion 32, a position at which the wall portion 30 is bent can be controlled to locate at, as shown in FIGS. 1, 3, and 17, just above the front end of the tapered portion 33. This fact leads to reduce the variation of the position of the bending point 320 and then it is possible to accommodate the device-side insulator 13 in the mounting hole of the hollow cylindrical housing 3 by the caulking force imparted by the caulked portion 32 thereof. As a result, for a long usage of the gas sensor 1 it is possible to keep a reliable hermeticity of the boundary between the atmospheric ambience 11 and the measured gas environment 12.

Moreover, since the slope of the outer surface of the tapered portion 33 in the axial direction θ is, as shown in FIG. 2, larger than or equal to 45 degrees, this embodiment ca produce the satisfactory effect of the present invention.

As stated above, in this embodiment it is capable of preventing the wall portion 30 of the hollow cylindrical housing 3 from applying an excessive concentration of stress onto a local region of the wall portion. Accordingly the device-side insulator 13 is allowed to be accommodated into the mounting hole of the hollow cylindrical housing 3 by the caulking force imparted by the caulked portion 32 thereof.

As a result, for a long usage of the gas sensor 1, it is possible to keep the hermeticity of the boundary between the atmospheric ambience 11 and the measured gas environment 12 in a reliable manner.

FIG. 16 shows a sectional view of a typical gas sensor.

The gas sensor includes a gas sensing element 92, a hollow cylindrical housing 93 having a mounting hole and a wall portion, an atmospheric-side cover 94. The sensing element 92 works to detect a specific gas in a measured gas. And the sensing element 92 is inserted into the mounting hole of the hollow cylindrical housing 93. The atmospheric-side cover 94 is supported with a body portion 931 provided at the base side of the hollow cylindrical housing 93.

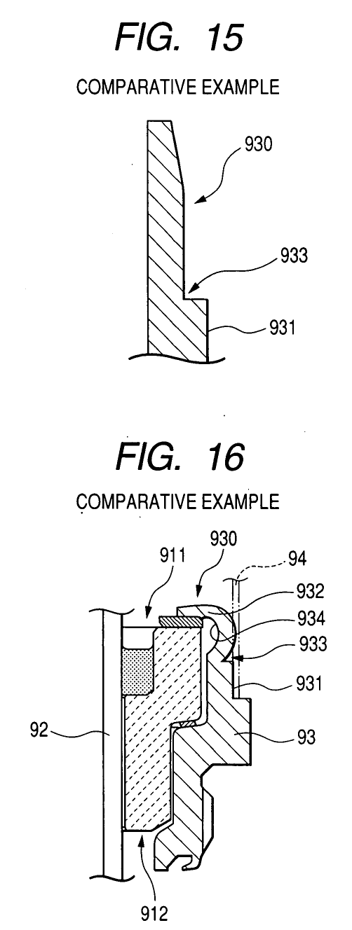

The hollow cylindrical housing 93 has, as shown in FIGS. 15 and 16, a caulking portion 932 which is formed by caulking a proximal end portion 930 of the wall portion in an inward direction and a stepwise changing portion 933.

The stepwise changing portion 933 is formed to have a step so as to vary in thickness suddenly along the axial direction. In such structure, it may be occurred that the atmospheric-side cover 94 can not be installed by the body portion 931 of the hollow cylindrical housing 93 due to a bulging the hollow cylindrical housing 93 in an outward direction.

Further it may occur that increasing the caulking load causes the variation of the bending position 934 beyond which the caulked portion 932 is formed.

Nevertheless a gas sensor according to the present invention is capable of overcoming the above mentioned difficulties.

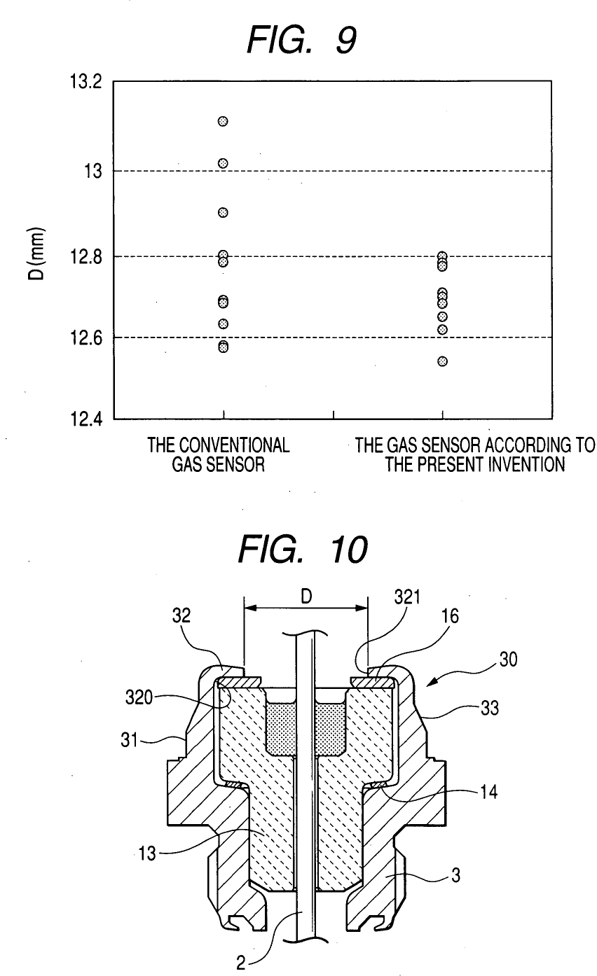

In FIG. 9 shows the graphical representation of the data concerning the variation of the bending position 920 of the caulked portion 32 both in the conventional type of a gas sensor and in the present type of a gas sensor.

In order to evaluate the variations, ten samples of the conventional type of gas sensor and ten samples of the gas sensor according to the present invention are prepared and the inner diameter D in FIG. 10 of the inner peripheral wall of the caulked portion 32 of each sample is measured.

The result is shown in FIG. 9. As will be seen from the graph in FIG. 9, the variations of the inner diameter D of the present type of the gas sensor is scattered in the range from 12.5 to 12.8 mm while the conventional type of gas sensors are in the range from 12.5 to 13.2 mm.

That is, according to the present invention, it is possible to reduce the variation of the bending position 320 satisfactorily.

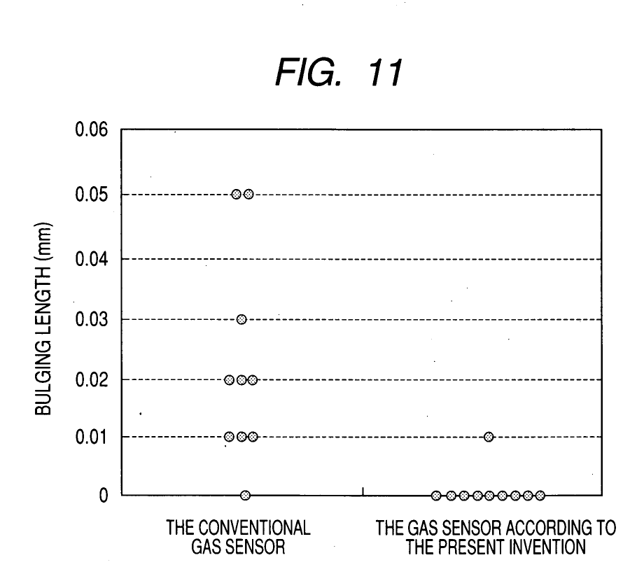

In FIG. 11, it is shown that the graphical representation of the data concerning the bulging length of the wall portion 30.

The bulging length is defined as the difference between the diameter of the outer surface 321 of the caulked portion 32 before caulking (see, FIG. 2) and that of the outer surface 321 of the caulked portion 32 after caulking (see, FIG. 3).

In order to evaluate the variations, ten samples of the conventional types of gas sensor and ten samples of the gas sensor according to the present invention are prepared and the bulging length of each sample is measured.

The result is shown in FIG. 11. As will be seen from the graph in FIG. 11, in the conventional type of the gas sensor there is the case where the bulging length is 0.05 mm. This result shows that the body portion 31 is bulged significantly by caulking.

On the other hand, in the gas sensor according to the present invention the bulging length is not greater than 0.01 mm. This shows that the body portion is not bulged by caulking at all.

That is, according to the present invention, it is possible to reduce the bulging length of the body portion 31 by caulking significantly.

In FIG. 11, it is shown that the graphical representation of the data concerning the bulging length of the wall portion 30 after caulking as a function of the slope θ of the outer surface of the tapered portion 33 being set before caulking. In order to evaluate the bulging length as a function of the slope θ, ten samples of the conventional type of the gas sensor and ten samples of the gas sensor according to the present invention are prepared and the bulging length of each sample is measured.

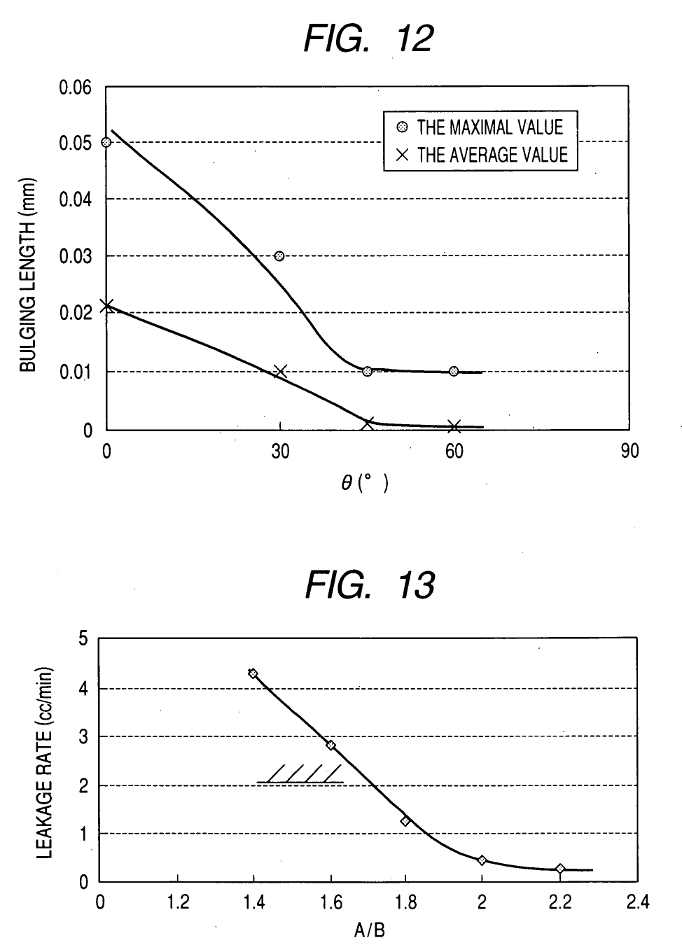

In FIG. 12, the black circle mark “•” indicates the maximal value of the bulging length among the samples having the given slope and the crossing mark “x” indicates the average value of the bulging length of these.

As will be seen in FIG. 12, in the case where the slope in the axial direction θ is 0 degree and the conventional type of the gas sensor, the maximal value of the bulging length is 0.05 mm and the average value is larger than 0.02 mm. As the slope θ is increasing until 45 degrees, both the maximal value and the average value of the bulging length are decreasing. When the slope θ goes beyond 45 degrees, both the curves of the maximal value and the average value of the bulging length are almost flattened.

Therefore it can be concluded that it is preferred to set the slope in the axial direction θ being greater then 45 degrees in the point of view of the bulging length of the wall portion 30.

### Second Embodiment

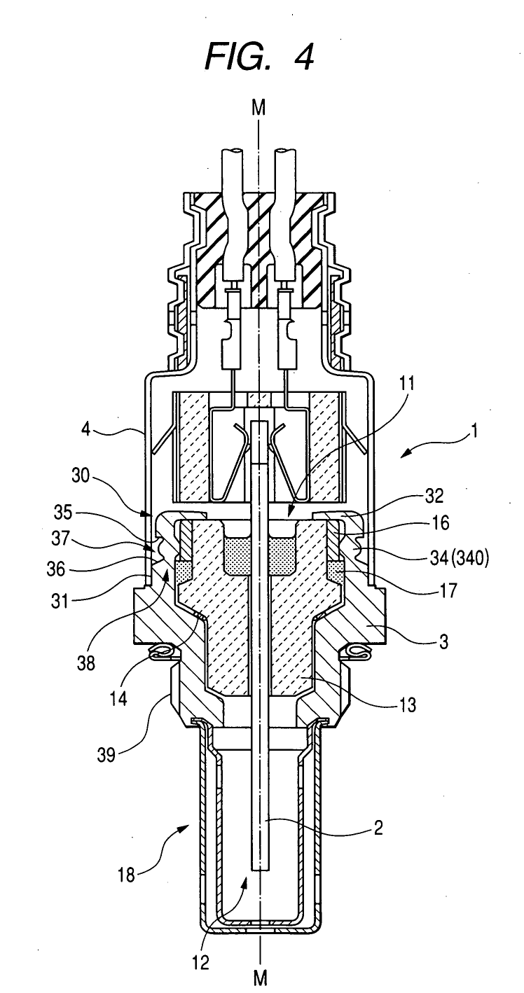

Referring FIGS. 4 to 7 and FIG. 18, a second embodiment of a gas sensor according to the present invention will now be described.

In this embodiment, the identical or similar components in structures to those in the first embodiment will be given the same reference numerals for avoiding redundant explanations.

This embodiment relates to, as shown in FIG. 4, a gas sensor 1 having a talc 17 and a packing 14 provided for hermetically sealing a distal end surface of an atmospheric ambience and a base end surface of a measured gas environment 12, and a production method of the same.

The wall portion 30 of the hollow cylindrical housing 3 according to this embodiment has a buckling portion 34 provided between the caulked portion 32 and the body portion 31. The buckling portion 34 is formed by buckling the thick portion 340. The thick portion 340 is smaller in thickness in the radial direction than both the maximum thickness of the caulked portion 32 and the body portion 31 of the wall portion 30. The thick portion 340 is formed by shaving off the outer surface of the wall portion 30.

Further the wall portion 30 has an expanding portion 35 provided between the buckling portion 34 and the body portion 31, and a tapered portion 36 provided between the caulked portion 32 and the body portion 31. The expanding portion 35 is shaped such that an outer peripheral surface thereof has a diameter becoming larger as approached from the buckling portion 34 to the caulked portion 32. The tapered portion is shaped such that an outer peripheral surface thereof has a diameter becoming smaller as approaching from the body portion 31 to the buckling portion 34.

As shown in FIG. 6, a maximum thickness of the buckling portion 34 and a minimum thickness of the buckling portion 34 satisfies a ratio of “A/B” which is larger than or equal to 2, where a reference “A” represents the maximum thickness and another reference “B” does the minimum thickness in the radial direction.

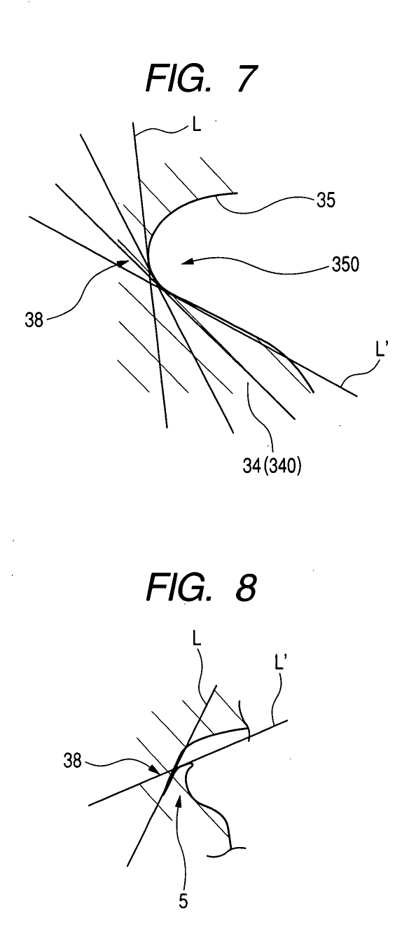

As shown in FIG. 7, a tangential line neighborhood of a position at which a diameter of the wall portion 30 has a minimum value having a tendency such that a slope of the tangential line along the axial direction, e.g., L and L′, continuously flatten as moving along the outer surface of the wall portion 30 from the minimum diameter position of the wall portion to the maximum diameter position. In other words, the outer peripheral surface of the wall portion 30 neighborhood of a position at which the wall portion has a minimum in diameter is described by a smooth, convex function in terms of an appropriate coordinate.

As shown in FIG. 4, a space defined by the device-side insulator 13 in the mounting hole of the hollow cylindrical housing 3 is filled with the talc 17 which is formed by compressing powdery inorganic material, and a filling material 16 such that both the talc 17 and the filling material 16 experience a caulking force imparted by the caulked portion 32 of the hollow cylindrical housing toward the distal end of the gas sensor 1. The filling material is formed of a metallic material.

That is, in the gas sensor according to the present embodiment, the packing 14 and the talc 17 are provided for hermetically sealing a distal end surface of an atmospheric ambience and a base end surface of a measured gas environment 12.

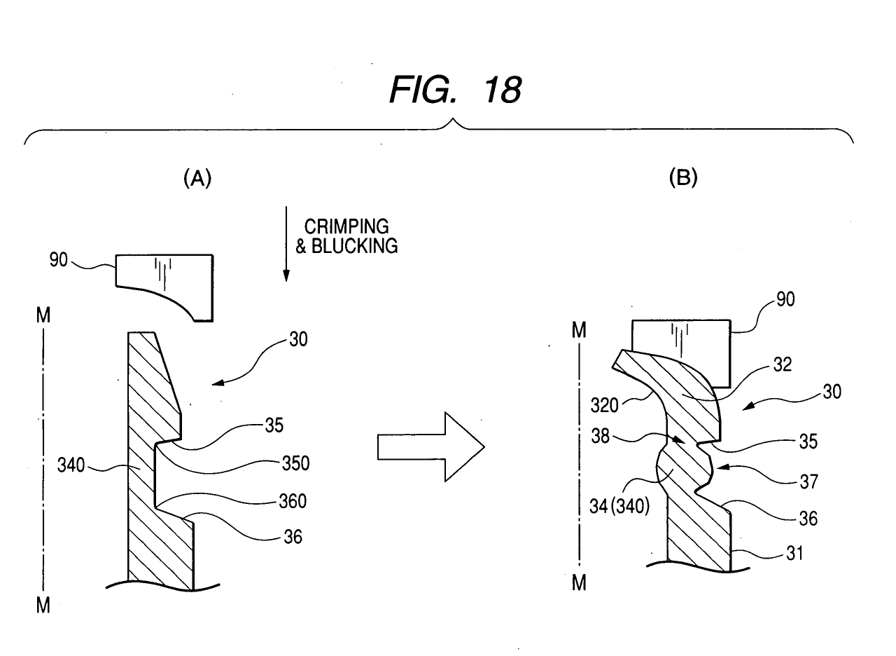

Referring to FIG. 18, a method of producing the gas sensor 1 according to the present embodiment will now be explained in part.

Before the device-side insulator 13 is accommodated into the mounting hole of the hollow cylindrical housing 3, the hollow cylindrical housing 3 has, as shown in FIG. 18(A), the thick portion 340, the expanding portion 35, and the tapered portion 36.

Moreover, a first joint section 350 between the expanding portion 35 and the thick portion 340 and a second joint section 360 between the tapered portion 36 and the thick portion 340 are shaped so as to be a smooth curve.

A radius of curvature of the surface of the first joint section 350 along the axial direction between the expanding portion 35 and the thick portion 340 and of the second joint section 360 between the tapered portion 36 and the thick portion 340 is in the range from 0.4 to 1.0 mm.

Then the processes in which an accommodation of the device-side insulator 13 fixedly holding the sensing element 2 in side thereof with the mounting hole of the hollow cylindrical housing 3, and a placement of the talc 17 and the filling material 16 in the space defined by the device-side insulator 13 in the mounting hole of the hollow cylindrical housing 3, will be performed. After that, the proximal end portion of the wall portion 30 is bent in an inward direction to form the caulked portion 32 by the pressure force imparted by a caulking material 90, as shown in FIG. 18 (B).

During fixedly holding the device-side insulator 13 inside the mounting hole of the hollow cylindrical housing 3, as shown in FIG. 18, buckling the thick portion 340 along the axial direction of the gas sensor 1 and caulking the proximal end portion of the wall portion to form the caulked portion 32 will be simultaneously carried out.

The caulking process, as shown in FIG. 6, will be carried out such that the relation of “A/B” is larger than or equal to 2 where a reference “A” represents the maximum thickness and a reference “B” does the minimum thickness in the radial direction, is satisfied.

The other features of the gas sensor 1 according to the present embodiment are identical to those given in the first embodiment.

The advantages of the gas sensor 1 produced by the method according to the present embodiment will be explained below.

As shown in FIG. 6, the hollow cylindrical housing 3 is structured so as to satisfy the relation saying A/B is larger than or equal to 2 where A represents the maximum thickness in the radial direction and B the minimum thickness in the radial direction. In FIG. 6, a maximum thickness portion 37 and a minimum thickness portion 38 can be seen. The maximum thickness portion 37 is defined as a position where the buckling portion 34 is largest in thickness in a radial direction and the minimum thickness portion 38 a position where the buckling portion 34 is smallest in thickness in a radial direction. The fact that the maximum thickness portion 37 is larger in thickness in a radial direction then twice of the minimum thickness portion 38 means that the thick portion 340 is well buckled along the axis of the gas sensor 1. Therefore the device-side insulator 13, the talc 17, and the filling material 16 which are accommodated into the mounting hole of the hollow cylindrical housing 3 experience the caulking force imparted by the caulked portion 32. As a result, for a long usage of the gas sensor it is possible to keep the reliable hermeticity of the boundary between the atmospheric ambience 11 and the measured gas environment 12.

As shown in FIG. 7, a tangential line neighborhood of a position at which a diameter of the wall portion 30 has a minimum value having a tendency such that a slope of the tangential line in the axial direction, e.g., L and L, continuously flatten as moving along the outer surface of the wall portion 30 from the minimum diameter position of the wall portion to the maximum diameter position. In other words, the outer surface of the wall portion 30 neighborhood of a position 38 at which the wall portion has a minimum in diameter is described by a smooth, convex function in terms of an appropriate coordinate. If it is not such a case, as shown in FIG. 8, an imperfection, such as a burr, is formed on the surface of the wall portion in machining. The imperfection on the surface becomes a potential source for a crack. In contrast, as shown in FIG. 7, a wall portion of the present embodiment does not have a surface on which an imperfection is formed, but has a smooth surface neighborhood of a position at which the wall portion has a minimum in diameter. Therefore at the section at which the wall portion is at a maximum in diameter, it is possible to prevent the possibility of a crack from occurring.

As a result, for a long usage of the gas sensor it is possible to keep the reliable hermeticity of the boundary between the atmospheric ambience and the measured gas environment.

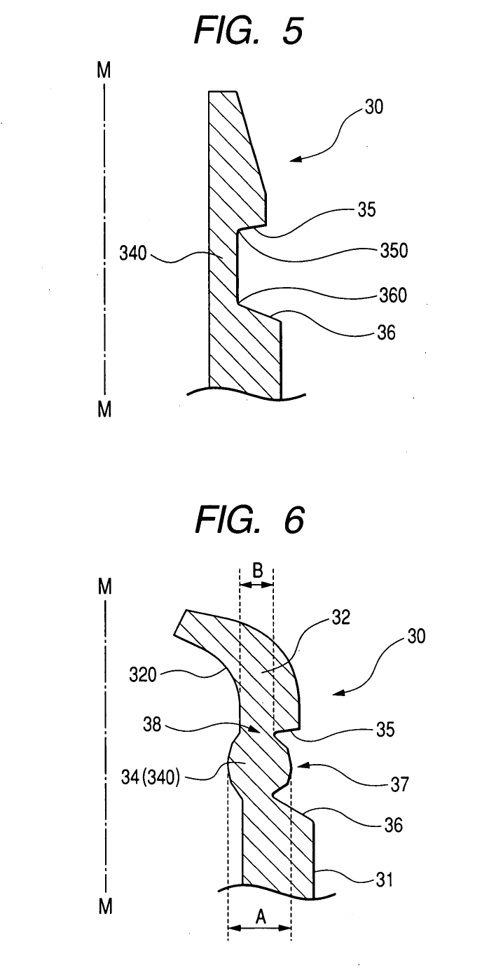

Before the device-side insulator 13 is accommodated into the mounting hole of the hollow cylindrical housing 3, the hollow cylindrical housing 3 has, as shown in FIG. 5, the thick portion 340, the expanding portion 35, and the tapered portion 36. Moreover, a first joint section 350 between the expanding portion 35 and the thick portion 340 and a second joint section 360 between the tapered portion 36 and the thick portion 340 are shaped so as to be smooth curve.

Therefore during forming of the caulked portion 32 by caulking, it is possible to prevent from applying an excessive concentration of stress on the first joint portion 350 or the second joint portion 360. Therefore it is capable of preventing from an occurring the possibility of a crack in the wall portion 30.

As shown in FIG. 7, the radius of curvature of the surface of the first joint portion 350 and the second joint portion 360 is limited in a range from 0.4 to 1.0 mm. Therefore it is possible to increase the caulking force and to prevent from applying an excessive concentration of stress on the first joint portion 350 or the second joint portion 360 satisfactorily.

Further, since the filling material 16 is made of a metallic material, even when the maximum thickness portion 37 of the buckling portion 34 is brought into contact with the filling material 16, it is capable of preventing the possibility of occurrence of a crack or a fracture in the filling material 16. Therefore it is possible to reliably keep the hermeticity of the boundary between the atmospheric ambience 11 and the measured gas environment 12 by a sufficiently strong caulking force.

As described above, it is possible to prevent from applying an excessive concentration of stress on the first joint portion 350 or the second joint portion 360 of the wall portion 30 of the hollow cylindrical housing 3. It is therefore capable of permitting the device-side insulator 13 to be accommodated into the mounting hole of the hollow cylindrical housing 3 by the caulking force imparted by the caulked portion 32.

As a result, for a long usage of the gas sensor, it is possible to reliably keep the hermeticity of the boundary between the atmospheric ambience 11 and the measured gas environment 12.

In FIG. 13, it is shown that the graphical representation of the data concerning the leakage rate in the gas sensor 1 according to this embodiment as a function of the value of a ratio A/B, where a reference A represents the maximum thickness and a reference B does the minimum thickness in the radial direction.

The leakage rate is defined as a volume of a gas per unit time flowing from the measured gas environment 12 into the atmospheric ambience 11.

As the value of A/B becomes larger, the thick portion 340 is more buckled toward the distal end of the gas sensor 1 in the axial direction.

As is clear from FIG. 13, if the ratio of A/B is greater then or equal to 2, the leakage rate can be suppressed so as to be smaller then or equal to 0.5 cc/min. Then it is possible to reduce the leakage rate to the sufficiently lower value. Moreover, if the ratio of A/B is smaller than or equal to 1.8, the leakage rate goes beyond 1.0 cc/min.

After the above mentioned discussion, in the point of view of reducing the leakage rate, it is preferable that the ratio of A/B is larger than or equal to 2.

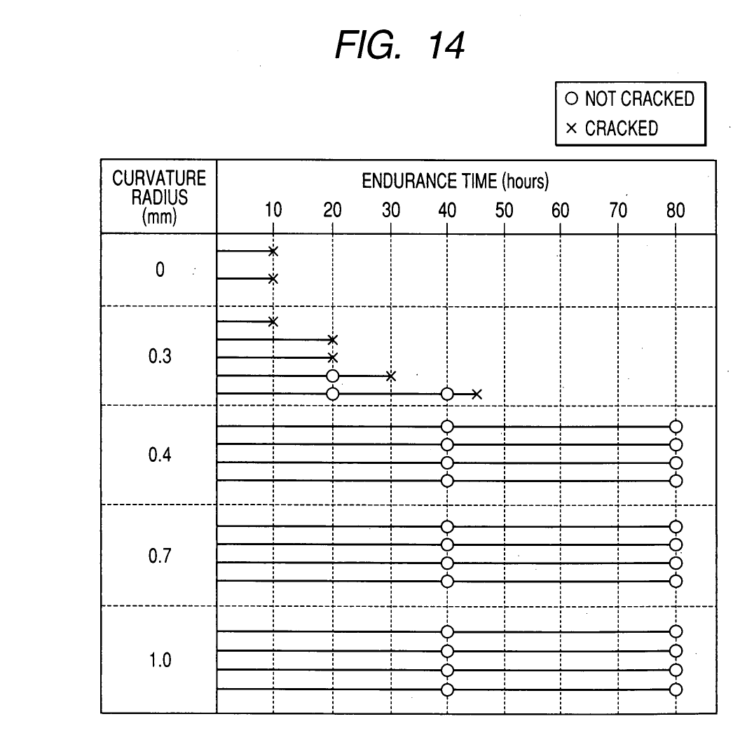

FIG. 14 shows the graphical representation of the data obtained from the endurance test in which the first time when the wall portion becomes cracked is measured in the gas sensors 1 according to this embodiment, each gas sensor having the several values of the radius of curvature of the surface along the axial direction of the first joint section 350 between the expanding portion 35 and the thick portion 340 and of the second joint section 360 between the tapered portion 36 and the thick portion 340.

In order to carry out endurance tests, there were prepared two samples of the gas sensor having the radius of curvature 0.0 mm, five samples of the gas sensor having the radius of curvature 0.3 mm, four samples of the gas sensor having the radius of curvature 0.4 mm, four samples of the gas sensor having the radius of curvature 0.7 mm, and four samples of the gas sensor having the radius of curvature 1.0 mm.

In the endurance tests, an impact load was set at 1000 G.

As shown in FIG. 14, all the two samples having the radius of curvature 0.0 mm were cracked in the endurance test for duration of 10 hours.

And, among the five samples having the radius of curvature 0.3 mm, one sample was cracked in the test for duration of less than 10 hours, and a total of three samples were cracked in the test for duration of less than 20 hours. Further, another sample was cracked within from 20 to 30 hours, and the last one was cracked after 40 hours and before 45 hours.

All of the four samples of the gas sensor having the radius of curvature 0.4 mm, four samples of the gas sensor having the radius of curvature 0.7 mm, and four samples of the gas sensor having the radius of curvature 1.0 mm, were not cracked in the endurance test for duration of 80 hours.

As described above, in the view of the endurance of the gas sensor 1, it is preferable that the surfaces of the first joint section 350 between the expanding portion 35 and the thick portion 340 and the second joint section 360 between the tapered portion 36 and the thick portion 340 have the radius of curvature 0.4 to 1.0 mm along the axial direction.

In contrast, if the radius of curvature is larger than 1.0 mm, it becomes difficult to obtain enough caulking force due to the difficulty of buckling the thick portion along the axial direction.

What is claimed is:

1. A gas sensor comprising:
a gas sensing element sensing information indicative of a concentration of a specific gas to be measured and having a longitudinal direction and a radial direction perpendicular to the longitudinal direction;
an insulator through which the gas sensing element is fixedly inserted; and
a housing having a hollow in which the insulator with the gas sensing element is inserted from an opening of hollow and having a wall portion positioned to form the opening in the longitudinal direction;
wherein the wall portion includes a caulked portion bent inward in the radial direction and has a thickness in the radial direction between an inner and outer wall surfaces, and the thickness and at least one of the inner and the outer wall surface change continuously in the longitudinal direction.

2. The gas sensor according to claim 1, further comprising:
the wall portion having a body portion at the distal end thereof to which an atmospheric-side cover is attached;
wherein the wall portion has a tapered portion provided between the body portion and the caulked portion in the longitudinal direction, and
the tapered portion being shaped such that an outer wall surface thereof having a diameter in the radial direction becoming smaller as approaching from the body portion to the caulked portion along the longitudinal direction of the gas sensor.

3. The gas sensor according to claim 2, wherein the tapered portion is formed such that a slope of the outer wall surface thereof is greater than or equal to 45 degrees.

4. The gas sensor according to claim 1, wherein
the wall portion has, in the longitudinal direction, a buckling portion provided between the caulked portion and the body portion, a tapered portion provided between the caulked portion and the buckling portion, and an expanding portion provided between the buckling portion and the body portion,
the tapered portion having an outer wall surface whose diameter in the radial direction becomes smaller as approaching from the body portion to the buckling portion along the longitudinal direction;
the expanding portion having an outer wall surface whose diameter becomes larger as approaching from the buckling portion to the caulked portion; and
the buckling portion being smaller in thickness in the radial direction than both the maximum thickness of the caulked portion and the body portion of the wall portion, and being formed by buckling a thick portion which is formed by shaving off the outer surface of the wall portion.

5. The gas sensor according to claim 4, wherein
a ratio of A/B is kept as to be larger than or equal to 2, where the reference “A” represents a maximum thickness of the buckling portion and the reference “B” represents a minimum thickness of the buckling portion between the inner and the outer surface thereof in the radial direction.

6. The gas sensor according to claim 4, wherein
a tangential line neighborhood of a position at which a diameter of the wall portion in the radial direction has a minimum value having a tendency such that a slope of the tangential line continuously flatten as moving along the outer wall surface of the wall portion from the minimum diameter position of the wall portion to the maximum diameter position in the longitudinal direction.

7. The gas sensor according to claim 5, wherein
the outer wall surface of the wall portion along the longitudinal direction neighborhood of a position at which the wall portion has a minimum in diameter in the radial direction being described by a smooth, convex function in terms of an appropriate coordinate.

8. A method for producing a gas sensor, comprising steps of:
preparing components including
a gas sensing element sensing information indicative of a concentration of a specific gas to be measured and having a longitudinal direction and a radial direction perpendicular to the longitudinal direction;
a housing having a hollow, a longitudinal direction, and a radial direction perpendicular to the longitudinal direction, and having a wall portion positioned to form the opening in the longitudinal direction, wherein the wall portion includes a proximal end portion having a thickness in the radial direction between an inner and an outer wall surfaces and being called a caulking portion after caulking, and the thickness and at least one of the inner and the outer wall surface change continuously in the longitudinal direction before caulking the proximal end portion; and
an insulator filling an interstices in the hollow between an outer surface of the gas sensing element and the inner wall surface;
inserting the gas sensing element from an opening of hollow into the housing through which the gas sensing element is inserted; and
caulking a proximal end portion of the wall portion inward in a plane perpendicular to the axial direction so as to form the caulked portion.

9. The method of producing gas sensor according to claim 8, wherein
the housing further has a wall portion having a body portion at the distal end thereof to which an atmospheric-side cover is attached; and
before the insulator is accommodated in the housing, the wall portion having at a distal end thereof a body portion supporting an atmospheric-side cover, at the other end to the distal end thereof a proximal end portion, a thick portion provided between the proximal end portion and the body portion, a tapered portion provided between the proximal end portion and the thick portion, and an expanding portion provided between the thick portion and the body portion;
the thick portion being smaller in thickness in the radial direction than both a maximum thickness of the proximal end portion and the body portion of the wall portion;
the tapered portion having an outer peripheral surface whose diameter becomes smaller as approaching from the body portion to the thick portion;
the expanding portion having an outer peripheral surface whose diameter becomes larger as approaching from the thick portion to the proximal end portion;
both a first joint section between the expanding portion and the thick portion and a second joint section between the tapered portion and the thick portion are shaped so as to be a smooth curve along the longitudinal direction; and
in order to make the insulator to be fixedly accommodated into the housing by the caulking force imparted by the caulked portion of the wall portion, both buckling the thick portion to form the buckling portion and bending the proximal end portion in an inward direction to form the caulking portion are performed.

10. The method of producing gas sensor according to claim 9, wherein the surface along the longitudinal direction of the first joint section between the expanding portion and the thick portion and the second joint section between the tapered portion and the thick portion has a surface whose curvature is in a range from 0.4 to 1.0 mm.

11. The method of producing gas sensor according to claim 9, wherein the caulking step is carried out such that, in cases where the maximum thickness of the proximal end portion is expressed by a reference “A” and a minimum thickness of the proximal end portion is expressed by a reference “B” a ratio of A/B is kept to be larger than or equal to 2.

12. The method of producing gas sensor according to claim 8, wherein the caulking step is carried out such that in cases where the maximum thickness of the proximal end portion is expressed by a reference “A” and a minimum thickness of the proximal end portion is expressed by a reference “B” a ratio of A/B is kept to be larger than or equal to 2.

13. A gas sensor comprising:
a gas sensing element sensing information indicative of a concentration of a specific gas to be measured and having a longitudinal direction and a radial direction perpendicular to the longitudinal direction;
an insulator through which the gas sensing element is fixedly inserted; and
a housing having a hollow in which the insulator with the gas sensing element is inserted from an opening of hollow and having a wall portion positioned to form the opening in the longitudinal direction;
wherein a wall portion includes a caulked portion bent inward in the radial direction, has a holding means so as to hold the insulator inside the hollow, and has a thickness in the radial direction between an inner and an outer wall surfaces, and the thickness and at least one of the inner and the outer wall surface change continuously in the longitudinal direction before caulking the caulked portion, and
the holding means is accompanied by exerting a caulked force imparted by the caulked portion on the insulator so as to hold fixedly the insulator into the hollow in a matter that a reaction force against the caulked force is distributed uniformly to an overall of the wall portion.

14. The gas sensor according to claim 13, comprising:
the wall portion further having a tapered portion provided between the body portion and the caulked portion in the longitudinal direction, and
wherein the tapered portion is formed such that a slope of the outer peripheral surface thereof is greater than or equal to 45 degrees.

15. The gas sensor according to claim 13, wherein
the proximal end portion of the hollow cylindrical housing further has, in the longitudinal direction, a buckling portion and an expanding portion such that the expanding portion, the buckling portion, and the tapered portion, are formed with the body portion in this order along the longitudinal direction;
the expanding portion having both a diameter of an outer wall surface thereof and a thickness thereof become larger as approaching from the buckling portion to the caulked portion; and
the buckling portion being smaller in thickness in the radial direction than both the maximum thickness of the caulked portion and the body portion of the proximal end portion of the housing, and being formed by buckling a thick portion which is formed by shaving off the outer surface of the proximal end portion of the housing.

16. The gas sensor according to claim 15, wherein
a ratio of A/B is kept as to be larger than or equal to 2, where the reference “A” represents a maximum thickness of the buckling portion and the reference “B” represents a minimum thickness of the buckling portion in the radial direction.

17. The gas sensor according to claim 15, wherein
a tangential line neighborhood of a position at which a diameter of the proximal end portion of the housing has a minimum value is shaped such that a slope of the tangential line continuously flatten as moving along the outer wall surface of the proximal end portion of the housing from the minimum diameter position of the proximal end portion of the housing to the maximum diameter position in the longitudinal direction.

18. The gas sensor according to claim 17, wherein
the outer wall surface of the proximal end portion of the housing along the axial direction neighborhood of a position at which the proximal end portion of the housing has a minimum in diameter along the radial direction being described by a smooth, convex function in terms of an appropriate coordinate.
